(19) United States
(12) Patent Application Publication
(10) Pub. No.: US 2015/0000522 A1
(43) Pub. Date: Jan. 1, 2015

(54) HIGH FREE VOLUME SILOXANE COMPOSITIONS USEFUL AS MEMBRANES

(71) Applicant: Dow Corning Corporation, Midland, MI (US)

(72) Inventors: Dongchan Ahn, Midland, MI (US); James S. Hrabal, St. Louis, MI (US); Alexandra N. Lichtor, Midland, MI (US)

(21) Appl. No.: 14/366,606

(22) PCT Filed: Dec. 27, 2012
(86) PCT No.: PCT/US12/71840

§ 371 Date: Jun. 18, 2014

Related U.S. Application Data
(60) Provisional application No. 61/580,437, filed on Dec. 27, 2011.
(60) Provisional application No. 61/580,434, filed on Dec. 27, 2011.

(51) Int. Cl. B01D 53/22; B01D 63/02; B01D 63/10; B01D 63/06; B01D 71/70; B01D 63/08

(52) U.S. Cl. CPC B01D 53/228; B01D 71/70; B01D 63/08; B01D 63/10; B01D 63/06; B01D 63/02; B01D 2053/221; B01D 2053/222; B01D 2053/223
USPC 95/52; 96/4; 96/10

(57) ABSTRACT

The present invention relates to hydrosilylation-curable silicone compositions that include an alkenyl-functional trialkylsilane compound. The present invention relates to a membrane including a cured product of the hydrosilylation-curable silicone composition. The present invention also relates to a method of making the membrane, and a method of separating components in a feed mixture using the membrane.

### CLAIM OF PRIORITY

This application claims the benefit of priority of U.S. Patent Application Ser. No. 61/580,437, entitled “HIGH FREE VOLUME SILOXANE COMPOSITIONS USEFUL AS MEMBRANES,” filed on Dec. 27, 2011, and of U.S. Patent Application Ser. No. 61/580,434, entitled “ORGANOPOLYSILOXANES INCLUDING SILICON-BONDED TRIALKYLSILYL-SUBSTITUTED ORGANIC GROUPS,” filed on Dec. 27, 2011, which applications are incorporated by reference herein in its entirety.

Artificial membranes can be used to perform separations on both a small and large scale, which makes them very useful in many settings. For example, membranes can be used to purify water, to cleanse blood during dialysis, and to separate gases or vapors. Some common driving forces used in membrane separations are pressure gradients and concentration gradients. Membranes can be made from polymeric structures, for example, and can have a variety of surface chemistries, structures, and production methods. Membranes can be made by hardening or curing a composition.

### SUMMARY OF THE INVENTION

The present invention relates to a membrane including a cured product of a hydrosilylation-curable silicone composition including an alkenyl-functional trialkylsilane. The present invention also relates to a method of making the membrane, and a method of separating gas components in a feed gas mixture using the membrane.

Various embodiments of the membrane of the present invention can exhibit beneficial and unexpected properties, for example, a higher modulus than conventional silicone rubber membranes, high free volume, high permeability for particular gases, and high selectivity for particular gases, such as gas components of a gas mixture. In some examples, the membranes of the present invention can exhibit a higher elastic modulus while retaining high CO₂/N₂ selectivity and retaining high permeability of PDMS membranes. In some embodiments, the membranes of the present invention can exhibit high fractional free volume. In some embodiments, the membranes of the present invention can exhibit high water vapor permeability, making them potentially useful as a means to humidify or dehumidify air. In some examples, the membranes of the present invention can have advantageous mechanical properties, for example compared to PDMS membranes, such as increased strength. In some embodiments, the membrane of the present invention advantageously has a fractional free volume higher than that of PDMS when calculated by the method of Bondi. For example, the fractional free volume can be greater than 0.20 when calculated by the method of Bondi.

In various embodiments, the present invention provides an unsupported membrane. The unsupported membrane includes a cured product of a hydrosilylation-curable silicone composition. The silicone composition includes (A) an organohydrogenpolysiloxane having an average of at least two silicon-bonded hydrogen atoms per molecule. The silicone composition also includes (B) a compound having an average of at least two aliphatic unsaturated carbon-carbon bonds per molecule. Component (B) is selected from (i) at least one organosilicon compound having an average of at least two aliphatic unsaturated carbon-carbon bonds per molecule, (ii) at least one organic compound having an average of at least two aliphatic unsaturated carbon-carbon bonds per molecule, and (iii) a mixture including (i) and (ii). The silicone composition also includes (C) a hydrosilylation catalyst. Additionally, the silicone composition includes (D) an alkenyl-functional trialkylsilan. The ratio of the moles of silicon-bonded hydrogen atoms in Component (A) to the sum of the number of moles of aliphatic unsaturated groups in Component (B) and Component (D) is about 0.1 to about 20. The membrane is unsupported.

In various embodiments, the present invention provides a coated substrate. The coated substrate includes a substrate. The coated substrate also includes a membrane including a cured product of a hydrosilylation-curable silicone composition. The silicone composition includes (A) an organohydrogenpolysiloxane having an average of at least two silicon-bonded hydrogen atoms per molecule. The silicone composition also includes (B) a compound having an average of at least two aliphatic unsaturated carbon-carbon bonds per molecule. Component (B) is selected from (i) at least one organosilicon compound having an average of at least two aliphatic unsaturated carbon-carbon bonds per molecule, (ii) at least one organic compound having an average of at least two aliphatic unsaturated carbon-carbon bonds per molecule, and (iii) a mixture including (i) and (ii). The silicone composition also includes (C) a hydrosilylation catalyst. The silicone composition also includes (D) an alkenyl-functional trialkylsilane. The ratio of the moles of silicon-bonded hydrogen atoms in Component (A) to the sum of the number of moles of aliphatic unsaturated groups in Component (B) and Component (D) is about 0.1 to about 20. The membrane has a water vapor permeability coefficient of about 5,000 Barrer to about 100,000 Barrer at about 22° C. The membrane is on at least part of the substrate.

In various embodiments, the present invention provides a method of separating gas components in a feed gas mixture. The method includes contacting a first side of a membrane including a cured product of a hydrosilylation-curable silicone composition with a feed gas mixture. The feed gas mixture includes at least a first gas component and a second gas component. The contacting produces a permeate gas mixture on a second side of the membrane and a retentate gas mixture on the first side of the membrane. The permeate gas mixture is enriched in the first gas component and the retentate gas mixture is depleted in the first gas component. The silicone composition includes (A) an organohydrogenpolysiloxane having an average of at least two silicon-bonded hydrogen atoms per molecule. The silicone composition also includes (B) a compound having an average of at least two aliphatic unsaturated carbon-carbon bonds per molecule. Component (B) is selected from (i) at least one organosilicon compound having an average of at least two aliphatic unsaturated carbon-carbon bonds per molecule, (ii) at least one organic compound having an average of at least two aliphatic unsaturated carbon-carbon bonds per molecule, and (iii) a mixture including (i) and (ii). The silicone composition also includes (C) a hydrosilylation catalyst. Additionally, the silicone composition includes (D) an alkenyl-functional trialkylsilane. The ratio of the moles of silicon-bonded hydrogen atoms in Component (A) to the sum of the number of moles of unsaturated aliphatic carbon-carbon bonds in Component (B) and Component (D) is about 0.1 to about 20. The membrane has a water vapor permeability of about 5,000 Barrer to about 100,000 Barrer at about 22° C.

### BRIEF DESCRIPTION OF THE FIGURES

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1 illustrates a differential scanning calorimetry spectrum of a cured product of Comparative Example C1.

FIG. 2 illustrates dynamic frequency sweeps of cured materials from Examples 2, 3, and C3, in accordance with various embodiments.

### DETAILED DESCRIPTION OF THE INVENTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

In the methods of manufacturing described herein, the steps can be carried out in any order without departing from the principles of the invention, except when a temporal or operational sequence is explicitly recited. Furthermore, specified steps can be carried out concurrently unless explicit claim language recites that they be carried out separately. For example, a claimed step of doing X and a claimed step of doing Y can be conducted simultaneously within a single operation, and the resulting process will fall within the literal scope of the claimed process

The term “about” can allow for a degree of variability in a value or range, for example, within 10%, within 5%, or within 1% of a stated value or of a stated limit of a range.

The term “organic group” as used herein refers to but is not limited to any carbon-containing functional group. Examples include acyl, cycloalkyl, aryl, aralkyl, heterocyclyl, heteroaryl, or heteroarylalkyl, linear and/or branched groups such as alkyl groups, fully or partially halogen-substituted haloalkyl groups, alkenyl groups, alkynyl groups, acrylate and methacrylate functional groups; and other organic functional groups such as ether groups, cyanate ester groups, ester groups, carboxylate salt groups, and masked isocyano groups.

The term “substituted” as used herein refers to an organic group as defined herein or molecule in which one or more hydrogen atoms contained therein are replaced by one or more non-hydrogen atoms. The term “functional group” or “substituent” as used herein refers to a group that can be or is substituted onto a molecule, or onto an organic group. Examples of substituents or functional groups include, but are not limited to, any organic group, a halogen (e.g., F, Cl, Br, and I); a sulfur atom in groups such as thiol groups, alkyl and aryl sulfide groups, sulfoxide groups, sulfone groups, sulfonyl groups, and sulfonamide groups; a nitrogen atom in groups such as amines, hydroxylamines, nitriles, nitro groups, N-oxides, hydrazides, azides, and enamines; and other heteroatoms in various other groups.

The term “alkyl” as used herein refers to straight chain and branched alkyl groups and cycloalkyl groups having from 1 to about 20 carbon atoms, and typically from 1 to 12 carbons or, in some embodiments, from 1 to 8 carbon atoms. Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, isobutyl, sec-butyl, t-butyl, neopentyl, isopentyl, and 2,2-dimethylpropyl groups. As used herein, the term “alkyl” encompasses all branched chain forms of alkyl. Representative substituted alkyl groups can be substituted one or more times with any functional group, for example, amino, hydroxy, cyano, carboxy, nitro, thio, alkoxy, and halogen groups.

The term “alkenyl” as used herein refers to straight and branched chain and cyclic alkyl groups as defined herein, except that at least one double bond exists between two carbon atoms. Thus, alkenyl groups have from 2 to about 20 carbon atoms, and typically from 2 to 12 carbons or, in some embodiments, from 2 to 8 carbon atoms. Examples include, but are not limited to vinyl, —CH═CH(CH₃), —CH═C(CH₃)₂, —C(CH₃)═CH₂, —C(CH₃)═CH(CH₃), —C(CH₂CH₃)═CH₂, cyclohexenyl, cyclopentenyl, cyclohexadienyl, butadienyl, pentadienyl, and hexadienyl, among others.

The term “aryl” as used herein refers to cyclic aromatic hydrocarbons that do not contain heteroatoms in the ring.

The term “resin” as used herein refers to polysiloxane material of any viscosity that includes at least one siloxane monomer that is bonded via a Si—O—Si bond to three or four other siloxane monomers. In one example, the polysiloxane material includes T or Q groups, as defined herein.

The term “radiation” as used herein refers to energetic particles travelling through a medium or space. Examples of radiation are visible light, infrared light, microwaves, radio waves, very low frequency waves, extremely low frequency waves, thermal radiation (heat), and black-body radiation.

The term “cure” as used herein refers to exposing to radiation in any form, heating, or allowing to undergo a physical or chemical reaction that results in hardening or an increase in viscosity.

The term “free-standing” or “unsupported” as used herein refers to a membrane with the majority of the surface area on each of the two major sides of the membrane not contacting a substrate, whether the substrate is porous or not. In some embodiments, a membrane that is “free-standing” or “unsupported” can be 100% not supported on both major sides. A membrane that is “free-standing” or “unsupported” can be supported at the edges or at the minority (e.g. less than about 50%) of the surface area on either or both major sides of the membrane.

The term “supported” as used herein refers to a membrane with the majority of the surface area on at least one of the two major sides contacting a substrate, whether the substrate is porous or not. In some embodiments, a membrane that is “supported” can be 100% supported on at least one side. A membrane that is “supported” can be supported at any suitable location at the majority (e.g. more than about 50%) of the surface area on either or both major sides of the membrane.

The term “selectivity” or “ideal selectivity” as used herein refers to the ratio of permeability of the faster permeating gas over the slower permeating gas, measured at room temperature.

The term “permeability” as used herein refers to the permeability coefficient (P_{X}) of substance X through a membrane, where q_{mX}=P_{X}*A*Δp_{X}*(1/delta), where q_{mX} is the volumetric flow rate of substance X through the membrane, A is the surface area of one major side of the membrane through which substance X flows, Δp_{X} is the pressure difference of the partial pressure of substance X across the membrane, and delta is the thickness of the membrane. Unless otherwise specified, the permeability coefficients cited refer to those measured at ambient laboratory temperatures, e.g. 22±2° C.

The term “Barrer” or “Barrers” as used herein refers to a unit of permeability, wherein 1 Barrer=10⁻¹¹ (cm³ gas) cm cm⁻² s⁻¹ mmHg⁻¹, or 10⁻¹⁰ (cm³ gas) cm cm⁻² s⁻¹ cm Hg⁻¹, where “cm³ gas” represents the quantity of the gas that would take up one cubic centimeter at standard temperature and pressure.

The term “total surface area” as used herein with respect to membranes refers to the total surface area of the side of the membrane exposed to the feed gas mixture.

The term “room temperature” as used herein refers to ambient temperature, which can be, for example, between about 15° C. and about 28° C.

The term “coating” refers to a continuous or discontinuous layer of material on the coated surface, wherein the layer of material can penetrate the surface and can fill areas such as pores, wherein the layer of material can have any three-dimensional shape, including a flat or curved plane. In one example, a coating can be formed on one or more surfaces, any of which may be porous or nonporous, by immersion in a bath of coating material.

The term “surface” refers to a boundary or side of an object, wherein the boundary or side can have any perimeter shape and can have any three-dimensional shape, including flat, curved, or angular, wherein the boundary or side can be continuous or discontinuous.

The term “mil” as used herein refers to a thousandth of an inch, such that 1 mil=0.001 inch.

The term “crosslinking agent” as used herein refers to any compound that can chemically react to link two other compounds together. The chemical reaction can include hydrosilylation.

The term “silane” as used herein refers to any compound having the formula Si(R)₄, wherein R is independently selected from any hydrogen, halogen, or optionally substituted organic group; in some embodiments, the organic group can include an organosubstituted siloxane group, such as an organomonosiloxane group, while in other embodiments, the organic group does not include a siloxane group. In some embodiments, one or more R groups in the formula Si(R)₄ is a hydrogen atom. In other embodiments, one or more R groups in the formula Si(R)₄ is not a hydrogen atom.

The term “number-average molecular weight” as used herein refers to the ordinary arithmetic mean or average of the molecular weight of individual molecules. It can be determined by measuring the molecular weight of n polymer molecules, summing the weights, and dividing by n.

The phrase “hydrosilylation-reactive components of the uncured composition” as used herein can include, for example, compounds having Si—H bonds, compounds including aliphatic unsaturated carbon-carbon bonds, and hydrosilylation catalyst.

The term “enrich” as used herein refers to increasing in quantity or concentration, such as of a liquid, gas, or solute. For example, a mixture of gases A and B can be enriched in gas A if the concentration or quantity of gas A is increased, for example by selective permeation of gas A through a membrane to add gas A to the mixture, or for example by selective permeation of gas B through a membrane to take gas B away from the mixture.

The term “deplete” as used herein refers to decreasing in quantity or concentration, such as of a liquid, gas, or solute. For example, a mixture of gases A and B can be depleted in gas B if the concentration or quantity of gas B is decreased, for example by selective permeation of gas B through a membrane to take gas B away from the mixture, or for example by selective permeation of gas A through a membrane to add gas A to the mixture.

### Hydrosilylation-Curable Silicone Composition

The present invention provides a hydrosilylation-curable silicone composition, a cured product of the hydrosilylation-curable silicone composition, and a membrane that includes a cured product of the hydrosilylation-curable silicone composition. In an embodiment, the composition includes (A) an organohydrogenpolysiloxane having an average of at least two silicon-bonded hydrogen atoms per molecule; (B) a compound having an average of at least two aliphatic unsaturated carbon-carbon bonds per molecule selected from (i) at least one organosilicon compound having an average of at least two aliphatic unsaturated carbon-carbon bonds per molecule, (ii) at least one organic compound having an average of at least two aliphatic unsaturated carbon-carbon bonds per molecule, and (iii) a mixture including (i) and (ii); (C) a hydrosilylation catalyst; and (D) an alkenyl-functional trialkylsilane.

The hydrosilylation-curable silicone composition of the present invention can include Component (A), an organohydrogenpolysiloxane having an average of at least two silicon-bonded hydrogen atoms per molecule. The organohydrogenpolysiloxane can be present in about 0.5 wt % to 80 wt %, 1 wt % to 70 wt %, 2 to 60 wt % or about 3 wt % to 50 wt % of the uncured composition. In some embodiments, the organohydrogenpolysiloxane can be present in about 1 wt % to 20 wt %, 2 wt % to 10 wt %, or about 3 wt % to 7 wt % of the uncured composition. In some embodiments, the organohydrogenpolysiloxane can be present in about 5 wt % to 50 wt %, 10 wt % to 40 wt %, 12 wt % to about 25 wt %, or about 15 wt % to 23 wt % of the uncured composition. In some embodiments, the organohydrogenpolysiloxane can be present in about 20 wt % to 60 wt %, 25 wt % to 55 wt %, 30 wt % to 50 wt %, 32 wt % to 48 wt %, 37 wt % to 46 wt %, or about 40 wt % to 44 wt % of the uncured composition. Wt % in this paragraph refers to the percent by weight based on the total weight of the hydrosilylation-reactive components of the uncured composition, including at least Components (A), (B), (C), and (D).

The hydrosilylation-curable silicone composition of the present invention can include Component (B), a compound having an average of at least two aliphatic unsaturated carbon-carbon bonds per molecule selected from (i) at least one organosilicon compound having an average of at least two aliphatic unsaturated carbon-carbon bonds per molecule, (ii) at least one organic compound having an average of at least two aliphatic unsaturated carbon-carbon bonds per molecule, and (iii) a mixture including (i) and (ii). Component (B) can be present in about 0.1 wt % to 99 wt %, 1 wt % to 98 wt %, 3 wt % to 97 wt %, or about 8 to 95 wt % of the uncured composition. In some embodiments, Component (B) can be present in about 30 wt % to 90 wt %, 50 wt % to 98 wt %, 65 wt % to 95 wt %, or about 85 wt % to 91 wt % of the uncured composition. In some embodiments, Component (B) can be present in about 30 wt % to 90 wt %, 32 wt % to 70 wt %, or about 35 wt % to 60 wt % of the uncured composition. In some embodiments, Component (B) can be present in about 30 wt % to 75 wt %, 40 wt % to 70 wt %, 45 wt % to 68 wt %, 46 wt % to 50 wt %, or about 60 wt % to 68 wt % of the uncured composition. In some embodiments, Component (B) can be present in about 0.1 wt % to 30 wt %, 0.5 wt % to 20 wt %, 1 wt % to 15 wt %, or about 5 wt % to 15 wt % of the uncured composition. Wt % in this paragraph refers to the percent by weight based on the total weight of the hydrosilylation-reactive components of the uncured composition, including at least Components (A), (B), (C), and (D).

The hydrosilylation-curable silicone composition of the present invention can include Component (C), a hydrosilylation catalyst. Component (C) can be present in about 0.00001 wt % to 20 wt %, 0.001 wt % to 10 wt %, or about 0.01 wt % to 3 wt % of the uncured composition. In some embodiments, the hydrosilylation catalyst can be present in about 0.001 wt % to 3 wt %, 0.01 wt % to 1 wt %, or about 0.1 wt % to 0.3 wt % of the uncured composition. Wt % in this paragraph refers to the percent by weight based on the total weight of the hydrosilylation-reactive components of the uncured composition, including at least Components (A), (B), (C), and (D).

The hydrosilylation-curable silicone composition of the present invention can include Component (D), an alkenyl-functional trialkylsilane. Component (D) can be present in about 1 wt % to 99 wt %, 3 wt % to 90 wt %, or about 5 wt % to 80 wt % of the uncured composition. In some embodiments, Component (D) can be present in about 1 wt % to 10 wt %, 2 wt % to 8 wt %, or about 4 wt % to 7 wt % of the uncured composition. In some embodiments, Component (D) can be present in about 10 wt % to 50 wt %, 15 wt % to 40 wt %, or about 20 wt % to 35 wt % of the uncured composition. In some embodiments, Component (D) can be present in about 20 wt % to 95 wt %, 30 wt % to 90 wt %, or about 45 wt % to 75 wt % of the uncured composition. Wt % in this paragraph refers to the percent by weight based on the total weight of the hydrosilylation-reactive components of the uncured composition, including at least Components (A), (B), (C), and (D).

### Component (A), Organohydrogenpolysiloxane

The uncured silicone composition of the present invention can include Component (A), an organohydrogenpolysiloxane. In some examples, the organohydrogenpolysiloxane compound has an average of at least one, two, or more than two silicon-bonded hydrogen atoms. The organopolysiloxane compound can have a linear, branched, cyclic, or resinous structure. The organopolysiloxane compound can be a homopolymer or a copolymer. The organopolysiloxane compound can be a disiloxane, trisiloxane, or polysiloxane. The silicon-bonded hydrogen atoms in the organosilicon compound can be located at terminal, pendant, or at both terminal and pendant positions.

The organohydrogenpolysiloxane compound can be a single organohydrogenpolysiloxane or a combination including two or more organohydrogenpolysiloxanes that differ in at least one of the following properties: structure, viscosity, average molecular weight, siloxane units, and sequence.

In one example, an organohydrogenpolysiloxane can include a compound of the formula

R^{x}₃SiO(R^{x}₂SiO)_{α}(R^{x}R²SiO)_{β}SiR^{x}₃, or (a)

R⁴R^{x}₂SiO(R^{x}₂SiO)_{χ}(R^{x}R⁴SiO)_{δ}SiR^{x}₂R⁴ (b)

In formula (a), a has an average value of about 0 to 500,000, and β has an average value of about 2 to 500,000. Each R^{x} is independently halogen, hydrogen, or an organic group such as acrylate; alkyl; alkoxy; halogenated hydrocarbon; alkenyl; alkynyl; aryl; heteroaryl; and cyanoalkyl. Each R² is independently H or R^{x}. In some embodiments, β is less than about 20, is at least 20, 40, 150, or is greater than about 200.

In formula (b), χ has an average value of 0 to 500,000, and δ has an average value of 0 to 500,000. Each R^{x} is independently as described above. Each R⁴ is independently H or R^{x}. In some embodiments, δ is less than about 20, is at least 20, 40, 150, or is greater than about 200.

Examples of organohydrogenpolysiloxanes can include compounds having the average unit formula

(R^{x}R⁴R⁵SiO_{1/2})_{w}(R^{x}R⁴SiO_{2/2})ₓ(R⁴SiO_{3/2})_{y}(SiO_{4/2})_{z} (I),

wherein each R^{x} is independently as defined above, R⁴ is H or R^{x}, R⁵ is H or R^{x}, 0≦w<0.95, 0≦x<1, 0≦y<1, 0≦z<0.95, and w+x+y+z=1. In some embodiments, R¹ is C₁₋₁₀ hydrocarbyl or C₁₋₁₀ halogen-substituted hydrocarbyl, both free of aliphatic unsaturation, or C₄ to C₁₄ aryl. In some embodiments, w is from 0.01 to 0.6, x is from 0 to 0.5, y is from 0 to 0.95, z is from 0 to 0.4, and w+x+y+z=1.

The organohydrogenpolysiloxane can have any suitable molecular weight. For example, the number-average molecular weight can be about 1,000-200,000 g/mol, 1,500-150,000, 2,400-100,000, 2,400-50,000, or about 1,000 to 40,000, or about 1,500, 2,000, 2,400, 3000, 3,500, 4,000, 4,500, or about 5,000 to about 40,000, 50,000, 75,000, 100,000, or to about 500,000 g/mol.

In some examples, Component (A) can include a dimethyl, methylhydrogen siloxane. In some examples, Component (A) can include a trimethylsiloxy-terminated polyhydridomethylsiloxane. In some examples, Component (A) can include a polydimethylsiloxane-polyhydridomethylsiloxane copolymer. In some embodiments, the composition may include combinations or mixtures of independently selected Component (A).

In descriptions of average unit formula, such as formula I, the subscripts w, x, y, and z are mole fractions. It is appreciated that those of skill in the art understand that for the average unit formula (I), each of the variables R¹, R⁴, and R⁵ can independently vary between individual siloxane formula units. Alternatively, each of the variables R¹, R⁴, and R⁵ can independently be the same between individual siloxane formula units. For example, average unit formula (I) above can include the following average unit formula:

(R¹R⁴R⁵SiO_{1/2})_{w}(R^{1a}R⁴SiO_{2/2})ₓ₁(R^{1b}R⁴SiO_{2/2})ₓ₂(R⁴SiO_{3/2})_{y}(SiO_{4/2})_{z}

wherein subscripts x1+x2=x, and where R^{1a} is not equal to R^{1b}. Alternatively, R^{1a} can be equal to R^{1b}.

### Component (B), Compound Having an Average of at Least Two Aliphatic Unsaturated Carbon-Carbon Bonds per Molecule

The uncured silicone composition of the present invention can include Component (B), a compound having an average of at least two aliphatic unsaturated carbon-carbon bonds per molecule. Component (B) can be any suitable compound having an average of at least two aliphatic unsaturated carbon-carbon bonds per molecule. In one embodiment, Component (B) can include (i) at least one organosilicon compound having an average of at least two aliphatic unsaturated carbon-carbon bonds per molecule, (ii) at least one organic compound having an average of at least two aliphatic unsaturated carbon-carbon bonds per molecule, or (iii) a mixture including (i) and (ii).

Component (B) can be present in any suitable concentration. In some examples, there are about 0.5, 1, 1.5, 2, 3, 5, 10, or about 20 moles of silicon-bonded hydrogen atoms, per mole of aliphatic unsaturated carbon-carbon bonds in the silicone composition, including those from at least Components (B), (C), and (D). In some embodiments, the mole ratio of silicon-bonded hydrogen atoms in Component (A) is about 0.001, 0.01, 0.1, 0.2, 0.3, 0.4, 0.5, 0.6, 0.7, 0.8, 0.9, 1, 5, 10, 15, 20, 30, 40, 50, 60, 70, 80, 90, 100, 150, about 200, or greater than about 200 per mole of aliphatic unsaturated carbon-carbon bonds in Component (B).

### Component (B), (i), Organosilicon Compound Having an Average of at Least Two Aliphatic Unsaturated Carbon-Carbon Bonds per Molecule

The hydrosilylation-curable silicone composition of the present invention can include an organosilicon compound having an average of at least two aliphatic unsaturated carbon-carbon bonds per molecule. The organosilicon compound having an average of at least two aliphatic unsaturated carbon-carbon bonds per molecule can be any suitable organosilicon compound having an average of at least two unsaturated carbon-carbon bonds per molecule, wherein each of the two unsaturated carbon-carbon bonds is independently or together part of a silicon-bonded group. In some embodiments, the organosilicon compound having an average or at least two aliphatic unsaturated carbon-carbon bonds per molecule can be an organosilicon compound having an average of at least two silicon-bonded aliphatic unsaturated carbon-carbon bond-containing groups per molecule. In some embodiments, the organosilicon compound can have an average of least three aliphatic unsaturated carbon-carbon bonds per molecule. Component (B)(i) can be present in the uncured silicone composition in an amount sufficient to allow at least partial curing of the silicone composition.

The organosilicon compound can be an organosilane or an organosiloxane. The organosilane can have any suitable number of silane groups, and the organosiloxane can be a disiloxane, trisiloxane, or polysiloxane. The structure of the organosilicon compound can be linear, branched, cyclic, or resinous. Cyclosilanes and cyclosiloxanes can have from 3 to 12 silicon atoms, alternatively from 3 to 10 silicon atoms, alternatively from 3 to 5 silicon atoms. In acyclic polysilanes and polysiloxanes, the aliphatic unsaturated carbon-carbon bonds can be located at terminal, pendant, or at both terminal and pendant positions.

Examples of organosilanes suitable for use as component (B)(i) include, but are not limited to, silanes having the following formulae: Vi₄Si, PhSiVi₃, MeSiVi₃, PhMeSiVi₂, Ph₂SiVi₂, and PhSi(CH₂CH═CH₂)₃, where Me is methyl, Ph is phenyl, and Vi is vinyl.

Examples of aliphatic unsaturated carbon-carbon bond-containing groups can include alkenyl groups such as vinyl, allyl, butenyl, and hexenyl; alkynyl groups such as ethynyl, propynyl, and butynyl; or acrylate-functional groups such as acryloyloxyalkyl or methacryloyloxypropyl.

In some embodiments, Component (B), (i) is an organopolysiloxane of the formula

R^{y}₃SiO(R^{y}₂SiO)_{α}(R^{y}R²SiO)_{β}SiR^{y}₃ (a)

R^{y}₂R⁴SiO(R^{y}₂SiO)_{χ}(R^{y}R⁴SiO)_{δ}SiR^{y}₂R⁴ (b)

or combinations thereof.

In formula (a), α has an average value of 0 to 2000, and β has an average value of 1 to 2000. Each R^{y} is independently halogen, hydrogen, or an organic group such as acrylate; alkyl; alkoxy; halogenated hydrocarbon; alkenyl; alkynyl; aryl; heteroaryl; and cyanoalkyl. Each R² is independently an unsaturated monovalent aliphatic carbon-carbon bond-containing group, as described herein.

In formula (b), χ has an average value of 0 to 2000, and δ has an average value of 1 to 2000. Each R^{y} is independently as defined above, and R⁴ is independently the same as defined for R² above.

Examples of organopolysiloxanes having an average of at least two aliphatic unsaturated carbon-carbon bonds per molecule include compounds having the average unit formula

(R¹R²R³SiO_{1/2})ₐ(R⁴R⁵SiO_{2/2})_{b}(R⁶SiO_{3/2})_{c}(SiO_{4/2})_{d} (I)

wherein each of R¹, R², R³, R⁴, R⁵, and R⁶ is an organic group independently selected from R^{y} as defined herein, 0≦a<0.95, 0≦b<1, 0≦c<1, 0≦d<0.95, a+b+c+d=1.

Component (B)(i) can be a single organosilicon compound or a mixture including two or more different organosilicon compounds, each as described herein. For example component (B)(i) can be a single organosilane, a mixture of two different organosilanes, a single organosiloxane, a mixture of two different organosiloxanes, or a mixture of an organosilane and an organosiloxane.

In some examples, Component (B)(i) can include a dimethylvinyl-terminated dimethyl siloxane, di methylvinylated and trimethylated silica, tetramethyl tetravinyl cyclotetrasiloxane, dimethylvinylsiloxy-terminated polydimethylsiloxane, trimethylsiloxy-terminated polydimethylsiloxane-polymethylvinylsiloxane copolymer, di methylvinylsiloxy-terminated polydimethylsiloxane-polymethylvinylsiloxane copolymer, or tetramethyldivinyldisiloxane. In some examples, the vinyl groups of the structures in the preceding list can be substituted with allyl, hexenyl, acrylic, methacrylic or other hydrosilylation-reactive unsaturated groups. In some examples, Component (B)(i) can include an organopolysiloxane resin consisting essentially of CH₂═CH(CH₃)₂SiO_{1/2} units, (CH₃)₃SiO_{1/2} units, and SiO_{4/2} units. In some examples, Component (B)(i) can include an oligomeric dimethylsiloxane(D)-methylvinylsiloxane(D^{Vi})diol.

Component (B), (ii), Organic Compound Having an Average of at Least Two Aliphatic Unsaturated Carbon-Carbon Bonds per Molecule

The hydrosilylation-curable silicone composition of the present invention can include an organic compound having an average of at least two aliphatic unsaturated carbon-carbon bonds per molecule. The aliphatic unsaturated carbon-carbon bonds can be alkenyl groups or alkynyl groups, for example.

Component (B)(ii) is at least one organic compound having an average of at least two aliphatic unsaturated carbon-carbon bonds per molecule. The organic compound can be any organic compound containing at least two aliphatic unsaturated carbon-carbon bonds per molecule, provided the compound does not prevent the organohydrogenpolysiloxane of the silicone composition from curing to form a cured product. The organic compound can be a diene, a triene, or a polyene. Also, the unsaturated compound can have a linear, branched, or cyclic structure. Further, in acyclic organic compounds, the unsaturated carbon-carbon bonds can be located at terminal, pendant, or at both terminal and pendant positions. Examples can include 1,4-butadiene, 1,6-hexadiene, 1,8-octadiene, and internally unsaturated variants thereof.

The organic compound can have a liquid or solid state at room temperature. Also, the organic compound is typically soluble in the silicone composition. The normal boiling point of the organic compound, which depends on the molecular weight, structure, and number and nature of functional groups in the compound, can vary over a wide range. In some embodiments, the organic compound has a normal boiling point greater than the cure temperature of the organohydrogenpolysiloxane, which can help prevent removal of appreciable amounts of the organic compound via volatilization during cure. The organic compound can have a molecular weight less than 500, alternatively less than 400, alternatively less than 300.

Component (B)(ii) can be a single organic compound or a mixture including two or more different organic compounds, each as described and exemplified herein. Moreover, methods of preparing unsaturated organic compounds are well-known in the art; many of these compounds are commercially available.

In one example, the organic compound having an average of at least two unsaturated carbon-carbon groups per molecule is a polyether having at least two aliphatic unsaturated carbon-carbon bonds per molecule. The polyether can be any polyalkylene oxide having at least two aliphatic unsaturated carbon-carbon bonds per molecule, or a halogen-substituted variant thereof.

### Component (C), Hydrosilylation Catalyst

The uncured silicone composition of the present invention can include a hydrosilylation catalyst. The hydrosilylation catalyst can be any suitable hydrosilylation catalyst.

The silicone composition in its pre-cured state includes at least one hydrosilylation catalyst. During curing of the silicone composition, the hydrosilylation catalyst can catalyze an addition reaction (hydrosilylation) of components of the silicone composition, for example, between silicon-bonded hydrogen atoms and alkenyl (or alkynyl) groups present in components of the composition.

In some embodiments, the hydrosilylation catalyst can be any hydrosilylation catalyst including a platinum group metal or a compound containing a platinum group metal. Platinum group metals include platinum, rhodium, ruthenium, palladium, osmium and iridium. The platinum group metal can be platinum, based on its high activity in hydrosilylation reactions.

Examples of hydrosilylation catalysts include the complexes of chloroplatinic acid and certain vinyl-containing organosiloxanes disclosed by Willing in U.S. Pat. No. 3,419,593, such as the reaction product of chloroplatinic acid and 1,3-divinyl-1,1,3,3-tetramethyldisiloxane; microencapsulated hydrosilylation catalysts including a platinum group metal encapsulated in a thermoplastic resin, as exemplified in U.S. Pat. No. 4,766,176 and U.S. Pat. No. 5,017,654; and photoactivated hydrosilylation catalysts, such as platinum(II) bis(2,4-pentanedioate), as exemplified in U.S. Pat. No. 7,799,842. An example of a suitable hydrosilylation catalyst includes a platinum(IV) complex of 1,3-diethenyl-1,1,3,3-tetramethyldisiloxane.

The at least one hydrosilylation catalyst can be a single hydrosilylation catalyst or a mixture including two or more different catalysts that differ in at least one property, such as structure, form, platinum group metal, complexing ligand, or thermoplastic resin.

### Component (D), Alkenyl-Functional Trialkylsilane

The uncured silicone composition of the present invention can include an alkenyl-functional trialkylsilane. The alkenyl-functional trialkyl silane can be any suitable alkenyl-functional trialkyl silane. The organic groups in component (D) may be halogen substituted to any extent, such as with fluorine atoms.

Examples of alkenyl-functional trialkylsilanes include compounds having the formula

R¹₃Si—(R²)_{c}—CR³═CR⁴₂,

wherein R¹ is independently a monovalent organic group such as C₁ to C₄ alkyl, R² is independently a divalent organic group or a siloxy group having the structure —O—Si(R^{1b})₂— wherein R^{1b} is independently C₁₋₁₀ alkyl or tri(C₁₋₁₀)alkylsiloxy, each of R³ and R⁴ is independently a monovalent organic group, and c is 0, 1, 2, 3, 4, 5, or 6. In some examples, R³ and R⁴ are hydrogen. In some examples each of R¹, R², R³ or R⁴ independently may be halogen substituted. In the linking-backbone of the linking group leading from the trialkylsilyl group to the alkene-group, a single siloxane group can be present; thus, if c=1, R² can be a siloxy group, and if c is greater than 1, one of the independently selected multiple R^{2a} can be a siloxy group. Therefore, in some embodiments, the alkenyl-functional trialkyl silane can be an alkenyl-functional trialkylsiloxy silane. In some embodiments, multiple siloxane groups can be excluded from the backbone of the linking group leading from the trialkylsilyl group to the alkenyl group. Multiple siloxy groups can occur in the linking group if they are appended to rather than part of the linking-backbone; thus, if R² is a siloxy group, R^{1b} can independently be a trimethylsiloxy group, for example. R^{1b} can independently include a single siloxy group; in various embodiments, multiple siloxane groups can independently be excluded from R^{1b}.

Other examples of alkenyl-functional trialkylsilanes include compounds having the formula

R¹_{d}Si[(R²)_{c}—CR³═CR⁴₂]ₑ,

wherein d+e=4, R¹ is independently a monovalent organic group, R² is independently a divalent organic group or a siloxy group having the structure —O—Si(R^{1b})₂— wherein R^{1b} is independently C₁₋₁₀ alkyl or tri(C₁₋₁₀)alkylsiloxy, each of R³ and R⁴ is independently a monovalent organic group or H, and c is 0, 1, 2, 3, 4, 5, or 6. In some examples, R³ and R⁴ are hydrogen. In some examples each of R¹, R², R³ or R⁴ can independently be halogen substituted. In the linking-backbone of the linking group leading from the trialkylsilyl group to each of the alkene-groups, a single siloxane group can be present; thus, if c=1, R² can be a siloxy group, and if c is greater than 1, one of the independently selected multiple R^{2a} for the particular alkenyl group can be a siloxy group. Therefore, in some embodiments, the alkenyl-functional trialkyl silane can be a bis- or tris(alkenyldialkylsiloxy)silane, such as for example tris(vinyldimethylsiloxy)methylsilane, or a di or trialkenylsilane such as for example trivinylmethylsilane. In some embodiments, multiple siloxane groups can be excluded from the backbone of the linking group leading from the trialkylsilyl group to each alkenyl group. Multiple siloxy groups can occur in the linking group if they are appended to rather than part of the linking-backbone; thus, if a particular R² is a siloxy group, R^{1b} for that particular alkenyl group can independently be a trimethylsiloxy group, for example. R^{1b} can independently include a single siloxy group; in various embodiments, multiple siloxane groups can independently be excluded from R^{1b}. See, for example, Examples 9 and 10.

Examples of the alkenyl-functional trialkylsilanes include vinyltrimethylsilane (VTMS), allyltrimethylsilane (ATMS), trivinylmethylsilane, vinyl-t-butyldimethylsilane, vinyldiethylmethylsilane, vinylmethylbis(trimethylsiloxy)silane, vinyltris(trimethylsiloxy)silane, allyltris(trimethylsiloxy)silane, vinyl(3,3,3-trifluoropropyl)dimethylsilane, vinyl(trifluoromethyl)dimethylsilane, vinylpentamethyldisiloxane, vinylnonafluorohexyldimethylsilane, or tris(trifluoropropyl)vinylsilane.

### Other Optional Ingredients

The membrane or the composition that forms the membrane can, in some embodiments, include additional components. Without limitation, examples of such optional additional components include surfactants, emulsifiers, dispersants, polymeric stabilizers, crosslinking agents, combinations of polymers, crosslinking agents, catalysts useful for providing a secondary polymerization or crosslinking of particles, rheology modifiers, density modifiers, aziridine stabilizers, cure modifiers such as hydroquinone and hindered amines, free radical initiators, polymers, diluents, acid acceptors, antioxidants, heat stabilizers, flame retardants, scavenging agents, silylating agents, foam stabilizers, solvents, diluents, hydrosilylation-reactive diluents, plasticizers, fillers and inorganic particles, pigments, dyes and dessicants. Liquids can optionally be used. An example of a liquid includes water, an organic solvent, any liquid organic compound, a silicone liquid, organic oils, ionic fluids, and supercritical fluids. Other optional ingredients include polyethers having at least one alkenyl group per molecule, thickening agents, fillers and inorganic particles, stabilizing agents, waxes or wax-like materials, silicones, organofunctional siloxanes, alkylmethylsiloxanes, siloxane resins, silicone gums, silicone carbinol fluids can be optional components, water soluble or water dispersible silicone polyether compositions, silicone rubber, hydrosilylation catalyst inhibitors, adhesion promoters, heat stabilizers, UV stabilizers, and flow control additives.

### Membrane

In one embodiment, the present invention provides a membrane that includes a cured product of the silicone composition described herein. In another embodiment, the present invention provides a method of forming a membrane. The present invention can include the step of forming a membrane. The membrane can be formed on at least one surface of a substrate. For any membrane to be considered “on” a substrate, the membrane can be attached (e.g. adhered) to the substrate, or be otherwise in contact with the substrate without being adhered. The substrate can have any surface texture, and can be porous or non-porous. The substrate can include surfaces that are not coated with a membrane by the step of forming a membrane. All surfaces of the substrate can be coated by the step of forming a membrane, one surface can be coated, or any number of surfaces can be coated.

The step of forming a membrane can include two steps. In the first step, the composition that forms the membrane can be applied to at least one surface of the substrate. In the second step, the applied composition that forms the membrane can be cured to form the membrane. In some embodiments, the curing process of the composition can begin before, during, or after application of the composition to the surface. The curing process transforms the composition that forms the membrane into the membrane. The composition that forms the membrane can be in a liquid state. The membrane can be in a solid state.

The composition that forms the membrane can be applied using conventional coating techniques, for example, immersion coating, die coating, blade coating, curtain coating, drawing down, solvent casting, spin coating, dipping, spraying, brushing, roll coating, extrusion, screen-printing, pad printing, or inkjet printing.

Curing the composition that forms the membrane can include the addition of a curing agent or initiator such as, for example, a hydrosilylation catalyst. In some embodiments, the curing process can begin immediately upon addition of the curing agent or initiator. The addition of the curing agent or initiator may not begin the curing process immediately, and can require additional curing steps. In other embodiments, the addition of the curing agent or initiator can begin the curing process immediately, and can also require additional curing steps. The addition of the curing agent or initiator can begin the curing process, but not bring it to a point where there composition is cured to the point of being fully cured, or of being unworkable. Thus, the curing agent or initiator can be added before or during the coating process, and further processing steps can complete the cure to form the membrane.

Curing the composition that forms the membrane can include a variety of methods, including exposing the polymer to ambient temperature, elevated temperature, moisture, or radiation. In some embodiments, curing the composition can include combination of methods.

The membrane of the present invention can have any suitable thickness. In some examples, the membrane has a thickness of about 1 μm to 20 μm. In some examples, the membrane has a thickness of about 0.1 μm to 200 μm. In other examples, the membrane has a thickness of about 0.01 μm to 2000 μm.

The membrane of the present invention can be selectively permeable to one substance over another. In one example, the membrane is selectively permeable to one gas over other gases or liquids. In another example, the membrane is selectively permeable to more than one gas over other gases or liquids. In one embodiment, the membrane is selectively permeable to one liquid over other liquids or gases. In another embodiment, the membrane is selectively permeable to more than one liquid over other liquids. In some examples, the membrane has an ideal CO₂/N₂ selectivity of at least about 5, 8, 9, or at least about 10. In some examples, the membrane has a CO₂/CH₄ selectivity of at least about 2, 2.5, 3, or at least about 4. In some embodiments, with a CO₂/N₂ mixture for example, the membrane has a CO₂ permeation coefficient of at least about 1000 Barrers, 1500, 2000, 2400, 2500, 2600, 3000, 3500, or at least about 4000 Barrers, to about 10,000 Barrers, at about 21° C. In some embodiments, the membrane has a water vapor permeability coefficient of about 5,000 Barrers to 100,000 Barrers, or about 10,000, 15,000, 20,000, 30,000, 35,000, or about 40,000 Barrers to 100,000 Barrers, at about 21° C.

The membrane of the present invention can have any suitable shape. In some examples, the membrane of the present invention is a plate-and-frame membrane, a spiral wound membrane, a tubular membrane, a capillary fiber membrane or a hollow fiber membrane. In some embodiments, the membrane may be used in conjunction with a liquid that enhances gas transport, such as in a membrane contactor (e.g. a device that permits mass transfer between a gaseous phase and a liquid phase across a membrane without dispersing the phases in one another).

### Supported Membrane

In some embodiments of the present invention, the membrane is supported on a porous or highly permeable non-porous substrate. A supported membrane has the majority of the surface area of at least one of the two major sides of the membrane contacting a porous or highly permeable non-porous substrate. A supported membrane on a porous substrate can be referred to as a composite membrane, where the membrane is a composite of the membrane and the porous substrate. The porous substrate on which the supported membrane is located can allow gases to pass through the pores and to reach the membrane. The supported membrane can be attached (e.g. adhered) to the porous substrate. The supported membrane can be in contact with the substrate without being adhered. The porous substrate can be partially integrated, fully integrated, or not integrated into the membrane.

A coating can be formed on the at least one porous surface of the substrate or on the at least one surface of the highly permeable non-porous substrate. Alternately, a porous or highly permeable non-porous substrate can be placed in contact with the formed coating before, during, or after curing of the coating. In some examples, a porous substrate can have its pores filled at the surface to provide a smooth surface for formation of a membrane; after formation of the membrane, the composition filling the pores can be dried or otherwise removed or shrunk to restore the porosity of the substrate. In some examples, the supported membrane is made in a manner identical to that disclosed herein pertaining to a free-standing membrane, but with the additional step of placing or adhering the free-standing membrane on a porous substrate to make a supported membrane.

The substrate can be any suitable shape, including planar, curved, or any combination thereof. Examples of porous substrates or highly permeable non-porous substrates include a sheet, tube or hollow fiber. The porous substrate or highly permeable non-porous substrate can be smooth, be corrugated or patterned, or have any amount of surface roughness.

The porous substrate can be any suitable porous material known to one of skill in the art, in any shape. For example, the substrate can be a filter. The porous substrate can be woven or non-woven. The porous substrate can be a frit, a porous sheet, or a porous hollow fiber. For example, the at least one surface can be flat, curved, or any combination thereof. The surface can have any perimeter shape. The porous substrate can have any number of surfaces, and can be any three-dimensional shape. Examples of three-dimensional shapes include cubes, spheres, cones, and planar sections thereof with any thickness, including variable thicknesses. The porous substrate can have any number of pores, and the pores can be of any size, depth, shape, and distribution. In one example, the porous substrate has a pore size of about 0.2 nm to 500 μm. The at least one surface can have any number of pores. In some examples, the pore size distribution may be asymmetric across the thickness of the porous sheet, film or fiber.

Suitable examples of porous substrates include porous polymeric films, fibers or hollow fibers, or porous polymers or any suitable shape or form. Examples of polymers that can form porous polymers suitable for use as a porous substrate in embodiments of the present invention include those disclosed in U.S. Pat. No. 7,858,197. For example, suitable polymers include polyethylene, polypropylene, polysulfones, polyamides, polyether ether ketone (PEEK), polyarylates, polyaramides, polyethers, polyarylethers, polyimides, polyetherimides, polyphthalamides, polyesters, polyacrylates, polymethacrylates, cellulose acetate, polycarbonates, polyacrylonitrile, polytetrafluoroethylene and other fluorinated polymers, polyvinylalcohol, polyvinylacetate, syndiotactic or amorphous polystyrene, Kevlar™ and other liquid crystalline polymers, epoxy resins, phenolic resins, polydimethylsiloxane elastomers, silicone resins, fluorosilicone elastomers, fluorosilicone resins, polyurethanes, and copolymers, blends or derivatives thereof. Suitable porous substrates can include, for example, porous glass, various forms and crystal forms of porous metals, ceramics and alloys, including porous alumina, zirconia, titania, and steel. Suitable porous substrates can include, for example, a support formed from the hydrosilylation-curable silicone composition of the present invention or formed using the method of surface treatment of the present invention, or a combination thereof.

### Unsupported Membrane

In some embodiments of the present invention, the membrane is unsupported, also referred to as free-standing. The majority of the surface area on each of the two major sides of a membrane that is free-standing is not contacting a substrate, whether the substrate is porous or not. In some embodiments, a membrane that is free-standing can be 100% unsupported. A membrane that is free-standing can be supported at the edges or at the minority (e.g. less than 50%) of the surface area on either or both major sides of the membrane. The support for a free-standing membrane can be a porous substrate or a nonporous substrate. Examples of suitable supports for a free-standing membrane can include any examples of supports given in the above section Supported Membrane. A free-standing membrane can have any suitable shape, regardless of the percent of the free-standing membrane that is supported. Examples of suitable shapes for free-standing membranes include, for example, squares, rectangles, circles, tubes, cubes, spheres, cones, and planar sections thereof, with any thickness, including variable thicknesses.

A support for a free-standing membrane can be attached to the membrane in any suitable manner, for example, by clamping, with use of adhesive, by melting the membrane to the edges of the substrate, or by chemically bonding the membrane to the substrate by any suitable means. The support for the free-standing membrane can be not attached to the membrane but in contact with the membrane and held in place by friction or gravity. The support can include, for example, a frame around the edges of the membrane, which can optionally include one or more cross-beam supports within the frame. The frame can be any suitable shape, including a square or circle, and the cross-beam supports, if any, can form any suitable shape within the frame. The frame can be any suitable thickness. The support can be, for example, a cross-hatch pattern of supports for the membrane, where the cross-hatch pattern has any suitable dimensions.

In some embodiments, a free-standing membrane is made by the steps of coating or applying a composition onto a substrate, curing the composition, and partially or fully removing the membrane from the substrate. After application of the composition to the substrate, the assembly can be referred to as a laminated film or fiber. During or after the curing process the membrane can be at least partially removed from at least one substrate. In some examples, after the unsupported membrane is removed from a substrate, and the unsupported membrane is attached to a support, as described above. In some examples, an unsupported membrane is made by the steps of coating a composition onto one or more substrates, curing the composition, and removing the membrane from at least one of the one or more substrates, while leaving at least one of the one of more substrates in contact with the membrane. In some embodiments, the membrane is entirely removed from the substrate. In one example, the membrane can be peeled away from the substrate. In one example, the substrate can be removed from the membrane by melting, subliming, chemical etching, or dissolving in a solvent. In one example, the substrate is a water soluble polymer that is dissolved by purging with water. In one example, the substrate is a fiber or hollow fiber, as described in U.S. Pat. No. 6,797,212 B2.

In examples that include a substrate, the substrate can be porous or nonporous. The substrate can be any suitable material, and can be any suitable shape, including planar, curved, solid, hollow, or any combination thereof. Suitable materials for porous or nonporous substrates include any materials described above as suitable for use as porous substrates in supported membranes, as well as any suitable less-porous materials. In some examples, the membrane can be heated, cooled, washed, etched or otherwise treated to facilitate removal from the substrate. In other examples, air pressure can be used to facilitate removal of the membrane from the substrate.

### Method of Separation

The present invention also provides a method of separating gas or vapor components in a feed gas mixture by use of the membrane described herein. The method includes contacting a first side of a membrane with a feed gas mixture to produce a permeate gas mixture on a second side of the membrane and a retentate gas mixture on the first side of the membrane. The permeate gas mixture is enriched in the first gas component. The retentate gas mixture is depleted in the first gas component. The permeate and retentate gas mixture can be enriched and depleted, respectively, in any suitable number of gas components. The membrane can include any suitable membrane as described herein.

The membrane can be free-standing or supported by a porous or permeable substrate. In some embodiments, the pressure on either side of the membrane can be about the same. In other embodiments, there can be a pressure differential between one side of the membrane and the other side of the membrane. For example, the pressure on the retentate side of the membrane can be higher than the pressure on the permeate side of the membrane. In other examples, the pressure on the permeate side of the membrane can be higher than the pressure on the retentate side of the membrane.

The feed gas mixture can include any mixture of gases or vapors. For example, the feed gas mixture can include air, hydrogen, carbon dioxide, nitrogen, ammonia, methane, water vapor, hydrogen sulfide, or any combination thereof. The feed gas can include any gas or vapor known to one of skill in the art. The membrane can be selectively permeable to any one gas in the feed gas, or to any of several gases in the feed gas. The membrane can be selectively permeable to all but any one gas in the feed gas.

Any number of membranes can be used to accomplish the separation. For example, one membrane can be used. The membranes can be manufactured as flat sheets or as fibers and can be packaged into any suitable variety of modules including hollow fibers, sheets or arrays of hollow fibers or sheets. Common module forms include hollow fiber modules, spiral wound modules, plate-and-frame modules, tubular modules and capillary fiber modules.

In embodiments, the membrane can be used to separate one or more liquids, gases, or vapors from one or more liquids, gases, or vapors.

The present invention can be better understood by reference to the following examples which are offered by way of illustration. The present invention is not limited to the examples given herein.

### Reference Example 1

### Membrane Preparation

Prior to preparing membranes, the compositions described in the Examples and Comparative Examples were placed in a vacuum chamber under a pressure of less than 50 mm Hg for 5 minutes at ambient laboratory temperature (21± about 2° C.) to remove any entrained air. Membranes were then prepared by drawing the composition described in the Examples into a uniform thin film with a doctor blade on a fluorosilicone-coated polyethylene terephthalate release film. The samples were then immediately placed into a forced air convection oven at a time and temperature sufficient to cure the films. For each composition, the curing schedule was determined by using differential scanning calorimetry to observe the temperatures at which the curing exotherms were observed. After curing, the membranes were then recovered by carefully peeling the cured compositions from the release film and transferred onto a fritted glass support for testing of permeation properties as described in Reference Example 2. The thickness of the samples was measured with a profilometer (Tencor P11 Surface Profiler).

### Reference Example 2

### Permeation Measurements

Gas permeability coefficients and ideal selectivities in a binary gas mixture were measured by a permeation cell including an upstream (feed) and downstream (permeate) chambers that are separated by the membrane. Each chamber has one gas inlet and one gas outlet. The upstream chamber was maintained at 35 psi pressure and was constantly supplied with an equimolar mixture of CO₂ and N₂ at a flow rate of 200 standard cubic centimeters per minute (sccm). The membrane was supported on a glass fiber filter disk with a diameter of 83 mm and a maximum pore diameter range of 10-20 μm (Ace Glass). The membrane area was defined by a placing a butyl rubber gasket with a diameter of 50 mm (Exotic Automatic & Supply) on top of the membrane. The downstream chamber was maintained at 5 psi pressure and was constantly supplied with a pure He stream at a flow rate of 20 sccm. To analyze the permeability and separation factor of the membrane, the outlet of the downstream chamber was connected to a 6-port injector equipped with a 1-mL injection loop. On command, the 6-port injector injected a 1-mL sample into a gas chromatograph (GC) equipped with a thermal conductivity detector (TCD). The amount of gas permeated through the membrane was calculated by calibrating the response of the TCD detector to the gases of interest. The reported values of gas permeability and selectivity were obtained from measurements taken after the system had reached a steady state in which the permeate side gas composition became invariant with time. All experiments were run at ambient laboratory temperature (21± about 2° C.).

Water Vapor Permeability Measurements.

Water vapor permeability coefficients were measured using the same permeation cell as described previously, with the same upstream and downstream chambers maintained at 35 psig and 5 psig, respectively, and with the same glass fiber filter disk support and butyl rubber gasket. A nitrogen supply of 140 sccm was provided, with 100 sccm of the nitrogen passing through a bubbler (Swagelok 500 mL steel cylinder containing water) to become saturated with water and 40 sccm of the nitrogen bypassing the bubbler and remaining dry. The wet and dry nitrogen streams then combined, and the relative humidity (RH) of the resultant feed stream was measured with a moisture transmitter (GE DewPro MMR31) and was determined to maintain a RH of about 69% under the experimental conditions. This stream was fed continuously into the upstream chamber of the permeation cell, and a helium sweep of 50 sccm was supplied continuously to the downstream chamber of the cell. The portion of the feed that permeated the membrane then combined with the helium sweep, and the resultant stream exited the downstream chamber. The RH of this stream was measured with a moisture transmitter (Omega HX86A) and the flow rate was measured with a soap bubble flow meter. The portion of the feed that did not permeate the membrane exited the upstream chamber as the retentate stream. The system was allowed to attain equilibrium, which was defined as the time at which the RH of both the feed stream and the stream exiting the downstream chamber remained constant. The water vapor permeability coefficient was calculated using the equation

$$\frac{\dot{Q}}{A} = \frac{P}{l} ( {[ RH * {p}_{sat} ]}_{feed} - {[ RH * {p}_{sat} ]}_{permeate} )$$

in which \dot{Q} is the volumetric flow rate of water vapor through the membrane, A is the area of the membrane, P is the permeability coefficient for water vapor, I is film thickness, and pₛₐₜ is saturation pressure. Nitrogen permeability was measured as described previously, in which the stream exiting the downstream chamber was analyzed by the GC. All experiments were run at ambient laboratory temperature.

### Reference Example 3

### Infrared Spectroscopy

Samples were tested at ambient laboratory conditions using a Nicolet 6700 FTIR equipped with a Smart Miracle attenuated total reflectance accessory having a zinc selenide crystal. Comparison of SiH signal heights among samples was done with identical baseline points and normalized by a suitable internal reference peak. Unreacted control samples were prepared and tested by blending the uncatalyzed reaction mixture in identical proportions to the final reactor contents for a given product.

### Reference Example 4

### Differential Scanning Calorimetry (DSC)

Samples were prepared by weighing less than 20 mg of sample into an aluminum DSC pan. The pan was hermetically sealed with a crimper then tested with a DSC (TA Instruments Q2000) ramped from −150° C. to 160° C. at a rate of 10° C./min.

### Reference Example 5

### Parallel Plate Rheology

Uncured samples were transferred from a sealed container to the gap between two 8 mm diameter parallel plates pre-heated at 70° C. in a TA Instruments ARES 4400 strain controlled rheometer and compressed to a final gap of 1.5 mm at room temperature. Excess sample was trimmed with a razor blade, then heated promptly in the environmental chamber to a temperature of 120° C. with the autotension feature activated to maintain a constant normal force during heating. The samples were allowed to complete in situ curing for 1 hour at 120° C. then cooled back to 25° C. under autotension. A frequency sweep was then conducted at 25° C. on the cured sample at a strain of 5% to determine its plateau dynamic storage modulus.

### Comparative Example C1

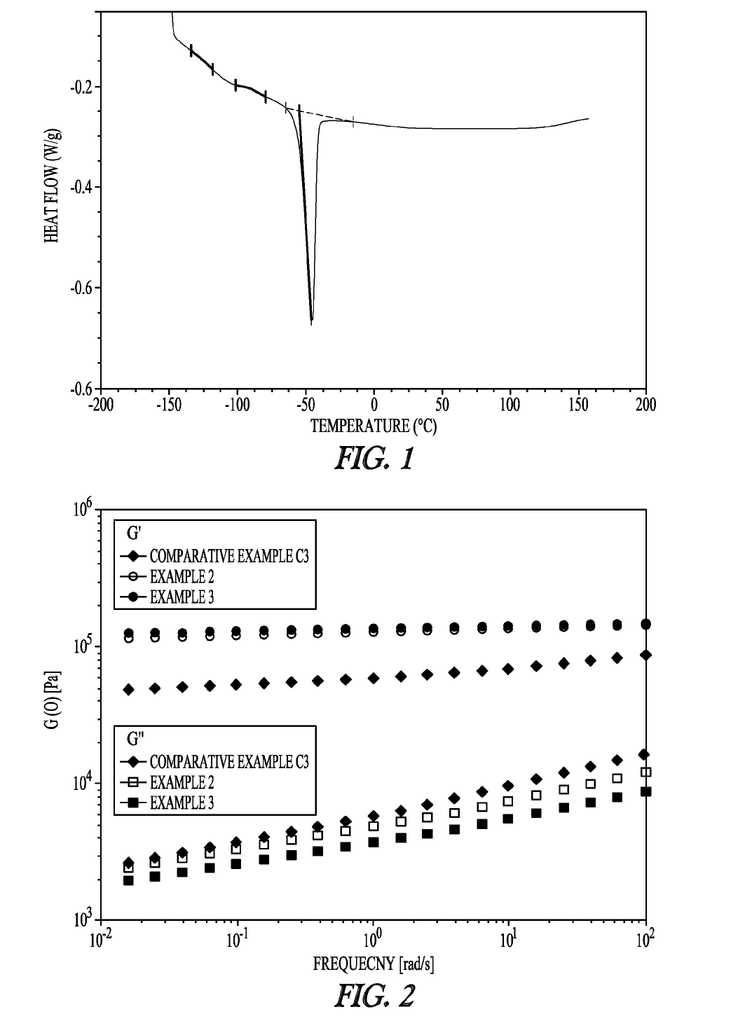

Dimethylvinylsiloxy-terminated polydimethylsiloxane having a viscosity of about 55 Pa·s at 25° C. (PDMS-1) was tested according to the method of Reference Example 4 and found to show a glass transition temperature of −125° C. and also showed a large endothermic melting peak at −46° C. preceded by a cold crystallization exothermic peak at −81° C., see FIG. 1.

### Comparative Example C2

PHMS 1 was tested according to the method of Reference Example 4 and found to show a glass transition temperature of −137° C. and no observable melting endotherm or cold crystallization peak.

### Example 1

Part A of a 2 part siloxane composition was prepared by combining a mixture including 99.6 parts of dimethylvinylsiloxy-terminated polydimethylsiloxane having a viscosity of about 55 Pa·s at 25° C. (PDMS1) and 0.4 parts of a catalyst (Catalyst 2) including a mixture of 1% of a platinum(IV) complex of 1,1-diethenyl-1,1,3,3-tetramethyldisiloxane, 92% of dimethylvinylsiloxy-terminated polydimethylsiloxane having a viscosity of about 0.45 Pa·s at 25° C., and 7% of tetramethyldivinyldisiloxane. The Part A was mixed in a Hauschild rotary mixer for two 20 s mixing cycles followed by a 40 s mix, with a manual spatula mixing step between the first two cycles. Part B of the 2 part siloxane composition was prepared in a similar manner by combining 87.0 parts of Vi-PDMS 1, and 12.6 parts of PHMS1, and 0.4 parts of 2-methyl-3-butyn-2-ol.

### Example 2

Five parts each of Part A and Part B described in Example 1 were combined in a polypropylene cup with 0.6 parts VTMS and mixed with a Hauschild rotary mixer for two 20 s cycles with a manual spatula mixing step in between cycles. The composition was drawn into a film, cured for 1 h at 150° C. and tested as described in Reference Examples 1, 2 and 5. The resulting membrane yielded a CO₂ permeability coefficient of 2520 Barrers, an N₂ permeability coefficient of 246 Barrers, and an ideal CO₂/N₂ selectivity of 10.25. When fed with nitrogen having 60% relative humidity, the membrane effected a substantial reduction in the relative humidity of the retentate stream and showed a water vapor permeability coefficient of 12,290 Barrers and a permeance of 1.55×10⁻⁴ cm³(STP)/(cm²-s-cm Hg). The composition was also cured in a parallel plate rheometer according to the method of Reference Example 5 and then subjected to dynamic mechanical testing at 25° C. As shown in FIG. 2, the cured material had a plateau storage modulus of about 0.13 MPa.

### Example 3

Five parts each of Part A and Part B described in Example 1 were combined in a polypropylene cup with 0.6 parts ATMS and mixed with a Hauschild rotary mixer for two 20 s cycles with a manual spatula mixing step in between cycles. The composition was drawn into a film, cured for 1 h at 150° C. and tested as described in Reference Examples 1, 2 and 5. The resulting membrane yielded a CO₂ permeability coefficient of 2685 Barrers, an N₂ permeability coefficient of 262 Barrers and an ideal CO₂/N₂ selectivity of 10.24. When fed with nitrogen having 60% relative humidity, the membrane effected a substantial reduction in the relative humidity of the retentate stream and showed a water vapor permeability coefficient of 15,290 Barrers and a permeance of 1.61×10⁻⁴ cm³(STP)/(cm²-s-cm Hg). The composition was also cured in a parallel plate rheometer according to the method of Reference Example 5 and then subjected to dynamic mechanical testing at 25° C. As shown in FIG. 2, the cured material had a plateau storage modulus of about 0.14 MPa.

### Comparative Example C3

Five parts each of Part A and Part B described in Example 1 were combined in a polypropylene cup and mixed with a Hauschild rotary mixer for two 20 s cycles with a manual spatula mixing step in between cycles. The composition was drawn into a film, cured for 1 h at 150° C. and tested as described in Reference Examples 1, 2 and 5. The resulting membrane yielded a CO₂ permeability coefficient of 2425 Barrers, a N₂ permeability coefficient of 209 Barrers and an ideal CO₂/N₂ selectivity of 11.56. When fed with nitrogen having 60% relative humidity, the membrane effected a substantial reduction in the relative humidity of the retentate stream and showed a water vapor permeability coefficient of 16,400 Barrers and a permeance of 1.44×10⁻⁴ cm³(STP)/(cm²-s-cm Hg). The composition was also cured in a parallel plate rheometer according to the method of Reference Example 5 and then subjected to dynamic mechanical testing at 25° C. As shown in FIG. 2, the cured material had a plateau storage modulus of about 0.07 MPa.

Examples 2 and 3 taken together with Comparative Example C3 demonstrate that embodiments provided by the present invention can provide a siloxane elastomer membrane that has CO₂ permeability coefficients at least as high as the unmodified siloxane elastomer, and that can remove water vapor from nitrogen at least as efficiently as the unmodified siloxane, while offering an increased modulus even at relatively low concentrations of the invention polymers. FIG. 2 shows dynamic frequency sweeps of cured materials from Examples 2, 3, and C3 obtained with a parallel plate rheometer at 25° C.

### Example 4

### Theoretical

Part B of a 2 part siloxane composition is prepared by combining 44.5 parts of Vi-PDMS 1, and 55.1 parts of PHMS1, and 0.4 parts of 2-methyl-3-butyn-2-ol. Five parts each of this Part B and Part A of Example 1 are combined in a polypropylene cup with 3.0 parts VTMS and mixed with a Hauschild rotary mixer for two 20 s cycles with a manual spatula mixing step in between cycles. The composition is drawn into a film, and cured for 30 min at 70° C. to yield a membrane.

### Example 5

### Theoretical

Five parts each of Part B and Part A used in Example 4 are combined in a polypropylene cup with 3.4 parts ATMS and mixed with a Hauschild rotary mixer for two 20 s cycles with a manual spatula mixing step in between cycles. The composition is drawn into a film, and cured for 30 min at 70° C. to yield a membrane.

### Example 6

### Theoretical

Five parts each of Part B and Part A used in Example 4 are combined in a polypropylene cup with 9.5 parts vinyltris(trimethylsiloxy)silane and mixed with a Hauschild rotary mixer for two 20 s cycles with a manual spatula mixing step in between cycles. The composition is drawn into a film, and cured for 30 min at 70° C. to yield a membrane.

### Example 7

### Theoretical

Five parts each of Part B and Part A used in Example 4 are combined in a polypropylene cup with 4.6 parts vinyl(trifluoromethyl)dimethylsilane and mixed with a Hauschild rotary mixer for two 20 s cycles with a manual spatula mixing step in between cycles. The composition is drawn into a film, and cured for 30 min at 70° C. to yield a membrane.

### Example 8

### Theoretical

Five parts each of Part B and Part A used in Example 4 are combined in a polypropylene cup with 9.9 parts allyltris(trimethylsiloxy)silane and mixed with a Hauschild rotary mixer for two 20 s cycles with a manual spatula mixing step in between cycles. The composition is drawn into a film, and cured for 30 min at 70° C. to yield a membrane.

### Example 9

### Theoretical

Part A of 2 part siloxane composition is prepared by combining a mixture including 33.4 parts Vi-PDMS 1 and 15.4 parts of organopolysiloxane resin consisting essentially of CH₂═CH(CH₃)₂SiO_{1/2} units, (CH₃)₃SiO_{1/2} units, and SiO_{4/2} units, wherein the mole ratio of CH₂═CH(CH₃)₂SiO_{1/2} units and (CH₃)₃SiO_{1/2} units combined to SiO_{4/2} units is about 0.7, and the resin has weight-average molecular weight of about 22,000, a polydispersity of about 5, and contains about 1.8% by weight (about 5.5 mole %) of vinyl groups, 48.8 parts of a vinyldimethylsiloxy terminated polydimethylsiloxane having a viscosity of about 0.03 Pa-s at 25° C. and 2.4 parts Catalyst 1. Part B of a 2 part siloxane composition is prepared in a similar manner by combining 51.8 parts VTMS, and 48.1 parts of PHMS1, and 0.1 parts of 2-methyl-3-butyn-2-ol. 10 g of Part B and 1 g of Part A of this Example are combined in a polypropylene cup mixed with a Hauschild rotary mixer for two 20 s cycles with a manual spatula mixing step in between cycles. The composition is drawn into a film, and cured for 30 min at 70° C. to yield a membrane.

### Example 10

### Theoretical

Part B of a 2 part siloxane composition is prepared by combining 55.0 parts ATMS, and 45.0 parts of PHMS1, and 0.1 parts of 2-methyl-3-butyn-2-ol. 10 g of this Part B and 1 g of Part A of Example 9 are combined in a polypropylene cup mixed with a Hauschild rotary mixer for two 20 s cycles with a manual spatula mixing step in between cycles. The composition is drawn into a film, and cured for 30 min at 70° C. to yield a membrane.

### Example 11

### Theoretical

Part B of a 2 part siloxane composition is prepared by combining 77.3 parts vinyltris(trimethylsiloxy)silane, and 22.6 parts of PHMS1, and 0.05 parts of 2-methyl-3-butyn-2-ol. 10 g of this Part B and 1 g of Part A of Example 9 are combined in a polypropylene cup mixed with a Hauschild rotary mixer for two 20 cycles with a manual spatula mixing step in between cycles. The composition is drawn into a film, and cured for 30 min at 70° C. to yield a membrane.

The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

1. An unsupported membrane comprising:
a cured product of a hydrosilylation-curable silicone composition, the silicone composition comprising
(A) an organohydrogenpolysiloxane having an average of at least two silicon-bonded hydrogen atoms per molecule;
(B) a compound having an average of at least two aliphatic unsaturated carbon-carbon bonds per molecule selected from
(i) at least one organo silicon compound having an average of at least two aliphatic unsaturated carbon-carbon bonds per molecule,
(ii) at least one organic compound having an average of at least two aliphatic unsaturated carbon-carbon bonds per molecule, and
(iii) a mixture comprising (i) and (ii);
(C) a hydrosilylation catalyst; and
(D) an alkenyl-functional trialkylsilane;
wherein the ratio of the moles of silicon-bonded hydrogen atoms in Component (A) to the sum of the number of moles of aliphatic unsaturated groups in Component (B) and Component (D) is about 0.1 to about 20,
wherein the membrane is unsupported.

2. The unsupported membrane of claim 1, wherein the membrane has a water vapor permeability coefficient of about 5,000 to about 100,000 Barrer at about 22° C.

3. The unsupported membrane of claim 1, wherein Component (A), the organohydrogenpolysiloxane having an average of at least two silicon-bonded hydrogen atoms per molecule, comprises at least one organopolysiloxane having the average siloxane unit formula:
(R¹R²R³SiO_{1/2})ₐ(R⁴R⁵SiO_{2/2})_{b}(R⁶SiO_{3/2})_{c}(SiO_{4/2})_{d} (I)
wherein each of R¹, R², R³, R⁴, R⁵, and R⁶ is an organic group independently selected from any C₁₋₁₅ organic group or H, 0≦a<0.95, 0≦b<1, 0≦c<1, 0≦d<0.95, a+b+c+d is approximately equal to 1, and the organohydrogenpolysiloxane has a number-average molecular weight of about 2,400 to 100,000 g/mol.

4. The unsupported membrane of claim 1, wherein Component (A), the organohydrogenpolysiloxane having an average of at least two silicon-bonded hydrogen atoms per molecule, is selected from the group consisting of a trimethylsiloxy-terminated polydimethylsiloxane-polyhydridomethylsiloxane copolymer, a trimethylsiloxy-terminated polyhydridomethylsiloxane.

5. The unsupported membrane of claim 1, wherein Component (B)(i), the at least one organo silicon compound having an average of at least two aliphatic unsaturated carbon-carbon bonds per molecule, comprises at least one organopolysiloxane compound having the average unit formula
(R^{1bi}R^{2bi}R^{3bi}SiO_{1/2})ₐ(R^{4bi}R^{5bi}SiO_{2/2})_{b}(R^{6bi}SiO_{3/2})_{c}(SiO_{4/2})_{d} (I)
wherein each of R^{1bi}, R^{2bi}, R^{3bi}, R^{4bi}, R^{5bi}, and R^{6bi} is an organic group independently selected from any C₁₋₁₅ organic group, including C₁₋₁₅ monovalent aliphatic hydrocarbon groups, C₄₋₁₅ monovalent aromatic hydrocarbon groups, and an alkenyl-containing organic group, 0≦a<0.95, 0≦b<1, 0≦c<1, 0≦d<0.95, a+b+c+d is approximately equal to 1.

6. The unsupported membrane of claim 1, wherein Component (B)(i), the at least one organo silicon compound having an average of at least two aliphatic unsaturated carbon-carbon bonds per molecule, is selected from the group consisting of a dimethylvinylsiloxy-terminated polydimethylsiloxane, and an organopolysiloxane resin including CH₂═CH(CH₃)₂SiO_{1/2} units, (CH₃)₃SiO_{1/2} units, and SiO_{4/2} units, wherein the mole ratio of CH₂═CH(CH₃)₂SiO_{1/2} units and (CH₃)₃SiO_{1/2} units combined to SiO_{4/2} units is about 0.7.

7. The unsupported membrane of claim 1, wherein Component (B)(ii), the at least one organic compound having an average of at least two aliphatic unsaturated carbon-carbon bonds per molecule, is at least one chosen from 1,4-butadiene, 1,6-hexadiene, 1,8-octadiene, a mono-allyl, mono-acetate terminated polyethylene glycol (AAPEG), a mono-allyl, mono-acetate terminated polyethylene glycol-polypropylene glycol copolymer (AAPEGPPG), 1,4-divinylbenzene, 1,3-hexadienylbenzene, 1,2-diethenylcyclobutane, trivinylmethylsilane, vinylmethylbis(trimethylsiloxy)silane, and vinyltris(trimethylsiloxy)silane.

8. The unsupported membrane of claim 1, wherein Component (C), the hydrosilylation catalyst, comprises a platinum group metal or a compound containing a platinum group metal.

9. The unsupported membrane of claim 1, wherein Component (D), the alkenyl-functional trialkylsilane, comprises a compound that has the formula
R^{1d}₃Si—(R^{2d})_{c}—CR^{3d}═CR^{4d}₂, or
wherein R^{1d} is C₁ to C₄ alkyl, R^{2d} is a divalent organic group, each of R^{3d} and R^{4d} is independently a monovalent organic group or H, and c is 0 or 1.

10. The unsupported membrane of claim 1, wherein Component (D), the alkenyl-functional trialkylsilane, comprises a compound that has the formula
R¹_{d}Si[(R²)_{c}—CR³═CR⁴₂]ₑ,
wherein d+e=4, e is at least 2, each R¹ is independently a monovalent organic group, each R² is independently a divalent organic group or a siloxy group having the structure —O—Si(R^{1b})₂— wherein each R^{1b} is independently C₁₋₁₀ alkyl or tri(C₁₋₁₀)alkylsiloxy, each of R³ and R⁴ is independently a monovalent organic group or H, and c is 0 or 1.

11. The unsupported membrane of claim 1, wherein Component (D), the alkenyl-functional trialkylsilane, is at least one chosen from vinyltrimethylsilane (VTMS), allyltrimethylsilane (ATMS), trivinylmethylsilane, vinyl-t-butyldimethylsilane, vinyldiethylmethylsilane, vinylmethylbis(trimethylsiloxy)silane, vinyltris(trimethylsiloxy)silane, vinyl(3,3,3-trffluoropropyl)dimethylsilane, vinyl(trifluoromethyl)dimethylsilane, vinylpentamethyldisiloxane, vinylnonafluorohexyldimethylsilane, and tris(trifluoropropyl)vinylsilane.

12. A coated substrate, comprising:
a substrate; and
a coating comprising a cured product of a hydrosilylation-curable silicone composition, the silicone composition comprising
(A) an organohydrogenpolysiloxane having an average of at least two silicon-bonded hydrogen atoms per molecule;
(B) a compound having an average of at least two aliphatic unsaturated carbon-carbon bonds per molecule selected from
(i) at least one organo silicon compound having an average of at least two aliphatic unsaturated carbon-carbon bonds per molecule,
(ii) at least one organic compound having an average of at least two aliphatic unsaturated carbon-carbon bonds per molecule, and
(iii) a mixture comprising (i) and (ii);
(C) a hydrosilylation catalyst; and
(D) an alkenyl-functional trialkylsilane;
wherein the ratio of the moles of silicon-bonded hydrogen atoms in Component (A) to the sum of the number of moles of aliphatic unsaturated groups in Component (B) and Component (D) is about 0.1 to about 20,
wherein the coating has a water vapor permeability coefficient of about 5,000 to about 100,000 Barrer at about 22° C.,
wherein the coating is on at least part of the substrate.

13. The coated substrate of claim 12, wherein the substrate is porous and the coating is a membrane, wherein the coated substrate is a supported membrane.

14. A method of separating gas components in a feed gas mixture, the method comprising:
contacting a first side of a membrane comprising a cured product of a hydrosilylation-curable silicone composition with a feed gas mixture comprising at least a first gas component and a second gas component to produce a permeate gas mixture on a second side of the membrane and a retentate gas mixture on the first side of the membrane,
wherein the permeate gas mixture is enriched in the first gas component and the retentate gas mixture is depleted in the first gas component,
wherein the silicone composition comprises
(A) an organohydrogenpolysiloxane having an average of at least two silicon-bonded hydrogen atoms per molecule;
(B) a compound having an average of at least two aliphatic unsaturated carbon-carbon bonds per molecule selected from
(i) at least one organo silicon compound having an average of at least two aliphatic unsaturated carbon-carbon bonds per molecule,
(ii) at least one organic compound having an average of at least two aliphatic unsaturated carbon-carbon bonds per molecule, and
(iii) a mixture comprising (i) and (ii);
(C) a hydrosilylation catalyst; and
(D) an alkenyl-functional trialkylsilane;
wherein the ratio of the moles of silicon-bonded hydrogen atoms in Component (A) to the sum of the number of moles of aliphatic unsaturated carbon-carbon bonds in Component (B) and Component (D) is about 0.1 to about 20;
wherein the membrane has a water vapor permeability of about 5,000 to about 100,000 Barrer at about 22° C.

15. The method of claim 14, wherein the feed gas mixture comprises carbon dioxide and nitrogen.

16. The method of claim 14, wherein the feed gas mixture comprises air and water vapor.

17. The unsupported membrane of claim 1, wherein the membrane has a thickness of about μm 0.1 to about 200 μm.

18. The unsupported membrane of claim 1, wherein the membrane is selected from a plate membrane, a spiral membrane, tubular membrane, hollow fiber membrane.

19. The coated substrate of claim 12, wherein the coated substrate is a supported membrane.

20. The coated substrate of claim 12, wherein the porous substrate is a frit comprising a material selected from glass, ceramic, alumina, and a porous polymer.
